(19) United States
(12) Patent Application Publication
(10) Pub. No.: US 2026/0140717 A1
(43) Pub. Date: May 21, 2026

(54) DEVICE APPLICATION LIBRARY WITH REUSABLE SERVICES

(71) Applicant: Rockwell Automation Technologies, Inc., Mayfield Heights, OH (US)

(72) Inventors: Jonathan A. Mills, Mayfield Heights, OH (US); Anthony J. DiBlasio, Independence, OH (US)

(21) Appl. No.: 19/039,356

(22) Filed: Jan. 28, 2025

Related U.S. Application Data
(60) Provisional application No. 63/721,184, filed on Nov. 15, 2024.

(51) Int. Cl. G06F 8/36; G06F 8/60

(52) U.S. Cl. CPC G06F 8/36; G06F 8/60

(57) ABSTRACT

Disclosed is a Unified Devices Architecture (UDA) system that provides for rapid development of device applications used across an industrial automation ecosystem that delivers common experiences through reuseable device application services. The UDA system allows a developer to select any number of device application services, which are specific to devices or host applications, to create a device application that is specific to an industrial automation device and a host application. In use, a host adapter allows the host application to dynamically select the correct device application for performing requested services.

### CROSS REFERENCE TO RELATED APPLICATIONS

This U.S. Patent Application claims priority to and the benefit of U.S. Provisional Patent Application 63/721,184, titled “DYNAMIC INTERFACING BETWEEN DEVICE APPLICATIONS AND DIFFERENT HOST PLATFORMS USING DEVICE APPLICATION LIBRARY WITH REUSEABLE SERVICES,” Attorney Docket Number 2024P-230-US-PROV, filed November 15, 2024, the contents of which is incorporated herein in its entirety for all purposes.

### BACKGROUND

Industrial automation environments include many different software applications for configuring, programming, and interacting with many different industrial automation devices. The various software applications tend to provide overlapping functionality with inconsistent interfaces, making development of new software applications difficult and the use of the resulting software applications overwhelming and confusing to users. Even among industrial automation devices and industrial automation software applications made by a single manufacturer, there are inconsistencies and a number of differing software applications. Because these systems have developed over many years, legacy software applications are often used even when new applications are developed because they serve different purposes, they offer different functionality, for cost reasons, and the like. Further, developing these new software applications is tedious to implement new functionality. Further still, when new industrial automation devices are created or modifications to the industrial automation devices or their means of communicating with software applications change, full-scale updates are often required to implement changes to the industrial automation software applications to implement the new devices or changes to existing devices. Accordingly, improvements are needed.

### SUMMARY

To address the issues described above, a unified device architecture for implementation in industrial automation environments is described herein. The unified device architecture features a library of device application services that can be used for rapid development of device applications. Each device application service implements a service that is relevant to one or more industrial automation devices or one or more industrial automation software host applications. The device applications use device application services to correspond to one industrial automation device and one industrial automation software host application. Device applications can be rapidly developed using the library of device application services. Further, the architecture allows for easy updating and adding device application services and device applications without rewriting the redeploying the industrial automation software host application.

These and other features and aspects of various examples may be understood in view of the following detailed discussion and accompanying drawings.

### BRIEF DESCRIPTION OF THE DRAWINGS

FIG. 1 illustrates a unified devices architecture in an industrial automation environment, according to some embodiments.

FIG. 2 illustrates unified devices architecture components, according to some embodiments.

FIG. 3 illustrates details of device application services, according to some embodiments.

FIG. 4 illustrates a unified devices architecture development environment, according to some embodiments.

FIG. 5 illustrates a software application implementation using the unified devices architecture, according to some embodiments.

FIG. 6A illustrates device application services reuse in a software application implementation using the unified devices architecture, according to some embodiments.

FIG. 6B illustrates device application services reuse across software application implementations using the unified devices architecture, according to some embodiments.

FIG. 7A illustrates a method of dynamic interfacing with the unified devices architecture, according to some embodiments.

FIG. 7B illustrates a method of rapid development of device applications using the unified devices architecture, according to some embodiments.

FIG. 8 illustrates an exemplary computing system suitable for implementing the various operational environments, architectures, environments, processes, scenarios, sequences, and frameworks discussed below with respect to the other FIGS.

### DETAILED DESCRIPTION

Industrial automation environments are often complex combinations of industrial automation devices and software applications that often communicate in various ways for monitoring, configuring, programming, and deployment. Industrial automation environments are unique in that they involve industrial automation devices, which have extensive and unique communication capabilities depending on the type of the device. Nonetheless, when configured, programmed, and deployed properly, they work together to complete industrial automation processes, such as bottling processes, oil refinery processes, automobile assembly processes, and many more. Accordingly, there are many types of industrial automation software applications including control logic development applications, industrial automation device monitoring applications, security and safety control applications, industrial automation design applications, and many more. Despite each of these types of applications needing access to similar information about and from and communications with the same industrial automation devices, the software applications are often developed in isolation, having little or no crossover between the software applications. As a result, as described above, the software applications provide inconsistent interfaces that are often overwhelming and confusing for users. Further, development of software applications as well as updates for new features, to include newly devised industrial automation devices, and so forth, requires extensive time and resources.

The unified device architecture for industrial automation environments described herein solves many of these issues. New industrial automation devices can be introduced, and implementation into the software environment is expedited with the use of a library of device application services. The device application services each implement a service corresponding to an industrial automation device or an industrial automation software host application. The device application services also implement a flexible Application Programming Interface (API) that allows flexible use among the many communication protocols used by the various industrial automation devices and industrial automation software host applications. The foundation of device application services provides consistent interface abilities and information when implemented across industrial automation devices and industrial automation software host applications.

Device applications are rapidly developed using the device application services as the foundation. Device applications implement a unique combination of device application services selected to support one industrial automation device and one industrial automation software host application. For example, an input/output (I/O) device may have many device application services related to it for device configuration, device data, communication type, and so forth. Further, a control logic development software application may have many device application services related to it for core services, application capabilities, communication type, and so forth. A device application can incorporate the I/O device specific device application services as well as the control logic development software application specific device application services such that the device application is specific to the control logic development software application and the I/O device. In this way, the control logic development software application can leverage the device application to interact with and provide an interface for the I/O device. Further, other device applications specific to other industrial automation software host applications can leverage the I/O device specific device application services to interact with and provide an interface for the I/O device. Similarly, other device applications specific to the control logic development software application can leverage the application specific device application services and device application services specific to other industrial automation devices to implement functionality for interacting with other industrial automation devices. Accordingly, the unified device architecture allows for extensive reuse of each device application service.

Furthermore, the architecture allows for a highly configurable environment. Selected industrial automation software host applications and device application services may be deployed based on the specific needs of the industrial automation environment. Additionally, if new industrial automation devices are added to the industrial automation environment, additional device application services and device applications can be created and/or deployed without modification to the industrial automation software host application.

Accordingly, the unified device architecture described herein provides extensive resource savings to industrial automation environments. The extensive reusability and configurability of the deployed architecture saves memory and computational resources at each installation or deployment site. In cloud implementations, the scale of economies across industrial automation environments can make memory and computational resource savings even greater. Further, time and computational resources are saved during development since device application services can be reused extensively for rapid development of device applications.

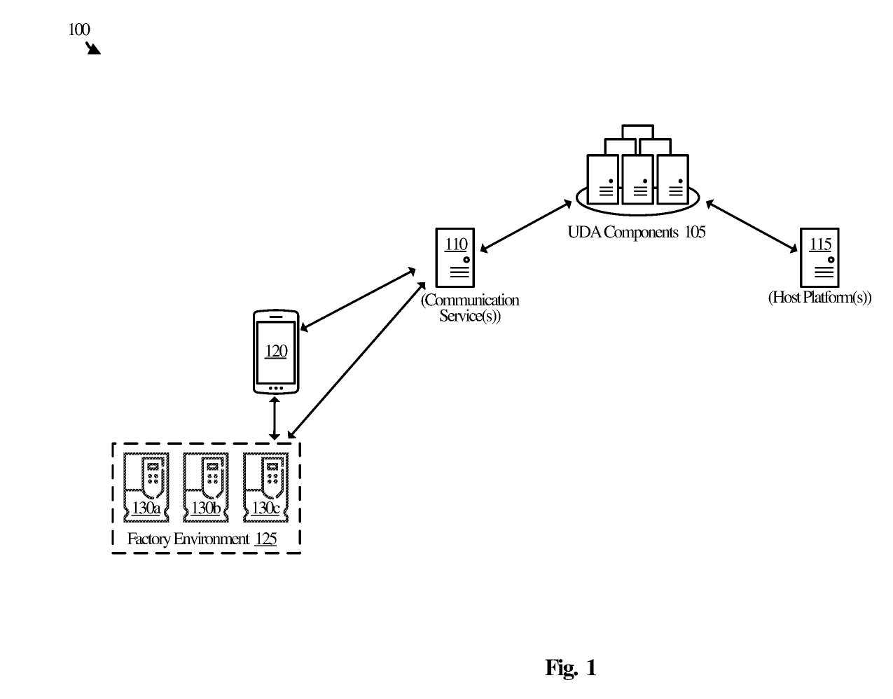

Turning to the figures, FIG. 1 illustrates an exemplary Unified Device Architecture (UDA) system 100 implemented in an industrial automation environment. System 100 includes factory environment 125, user device 120, communication services 110, UDA components 105, and host platforms 115. While other elements may be included in system 100, they are not depicted here for clarity.

Factory environment 125 represents an industrial automation factory (e.g., the factory floor including multiple factory locations) and ancillary locations (e.g., office spaces or other remote locations) related to the factory and, in particular, the industrial automation devices 130 therein. Industrial automation devices 130 represent all devices within factory environment 125. While three industrial automation devices 130a, 130b, and 130c are depicted, any number of industrial automation devices 130 may be included in factory environment 125. For example, factory environment 125 may include an automobile manufacturing factory with factory floors in Detroit, Michigan and Chicago, Illinois. Industrial automation devices may include any type of device used in the factory environment 125 including, for example, motor drives, programmable logic controllers, I/O devices, circuit breakers, sensors, switches, conveyors, robots, robotic arms, and the like.

User device 120 may be any computing system (e.g., computing system 801) used to access host platforms 115 via communication services 110 for interacting with industrial automation devices 130 in factory environment 125. User device 120 may be a mobile device such as a cell phone, tablet, or laptop, a desktop computer, a server computer, a terminal device such as a Human Machine Interface, or the like. While user device 120 is depicted outside of factory environment 125, user device 120 may also be located within factory environment 125.

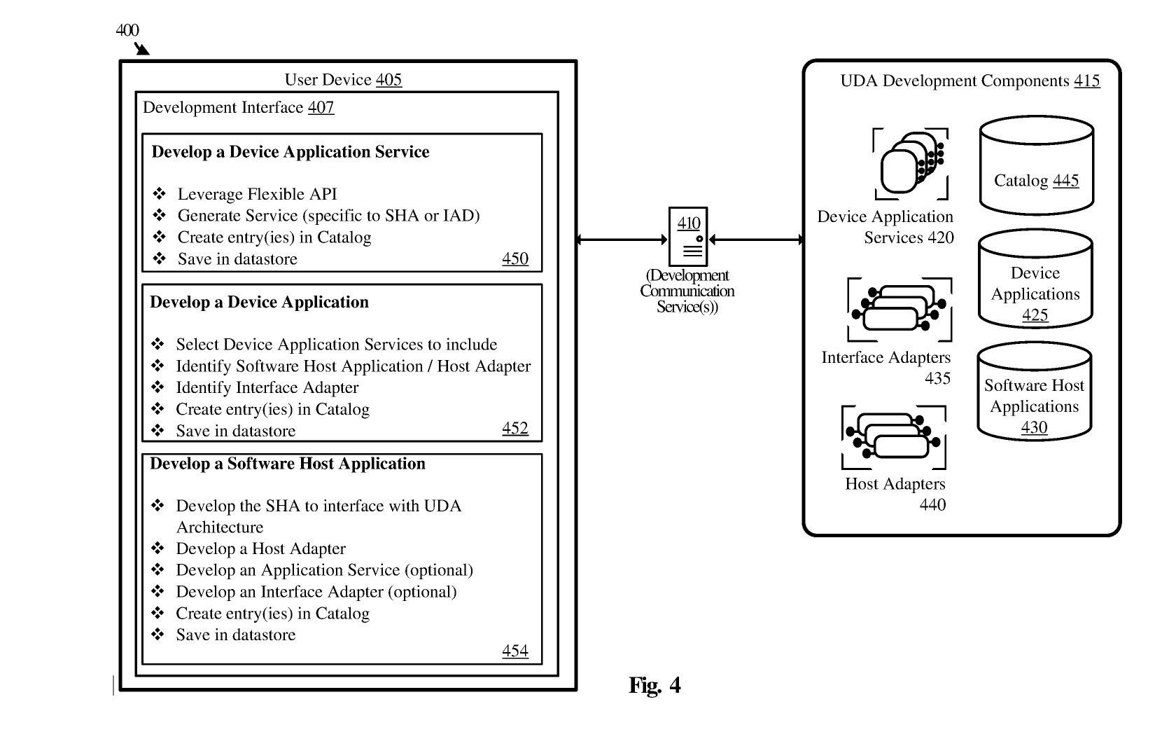

Host platforms 115 may be hosted on one or more computing systems (e.g., computing system 801). Host platforms 115 may be hosted on premises or cloud hosted in various embodiments. Host platforms 115 are deployed industrial automation software host applications (e.g., software host applications 430 described and illustrated with respect to FIG. 4). A single computing system may serve more than one software host application (i.e., host platform 115). There may be many host platforms 115 in various embodiments. For example, system 100 may include host platforms 115 that include a logic control development software application (e.g., LOGIX DESIGNER by ROCKWELL SOFTWARE), an industrial automation design software application (e.g., FACTORYTALK DESIGN STUDIO by ROCKWELL SOFTWARE), mobility software applications for interacting with industrial automation devices on mobile devices, industrial automation device health monitoring applications (e.g., GUARDIANAI by ROCKWELL SOFTWARE), and the like. Host platforms 115 include functionality for interacting with, communicating with, programming, monitoring, or otherwise accessing industrial automation devices 130.

Communication services 110 provides an interface (e.g., a graphical user interface, communication interface) for user device 120 and industrial automation devices 130 to access host platforms 115. For example, a user may access a host platform 115a (e.g., an industrial automation device monitoring application) on user device 120 via communication service 110a. Communication services 110 may, for example, generate and serve the graphical user interface to user device 120. In some embodiments, communication services 110 may interact directly with industrial automation device 130 to, for example, retrieve data, provide updates or configurations, or the like. In some embodiments, there may be a communication service 110 for each host platform 115. In some embodiments, a single communication service 110 may be used for more than one of host platforms 115 or all host platforms 115.

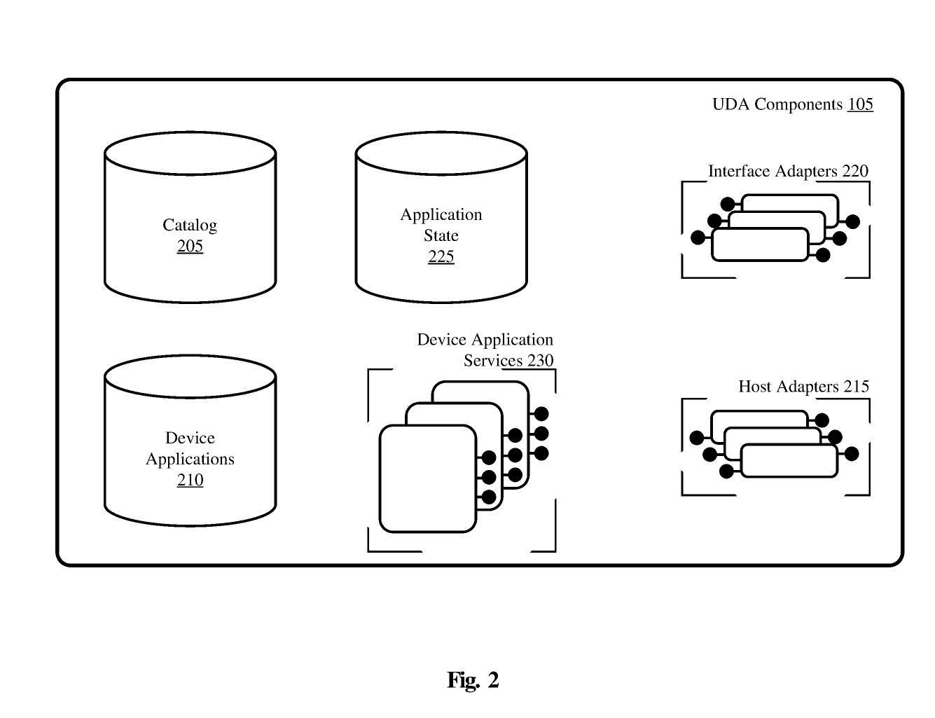

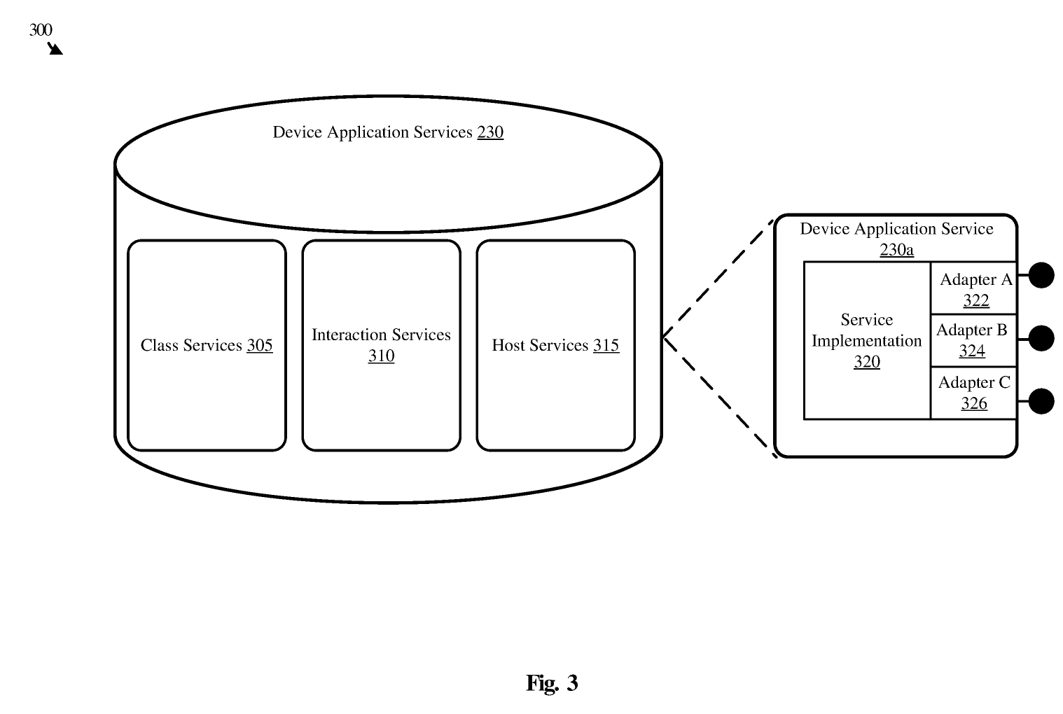

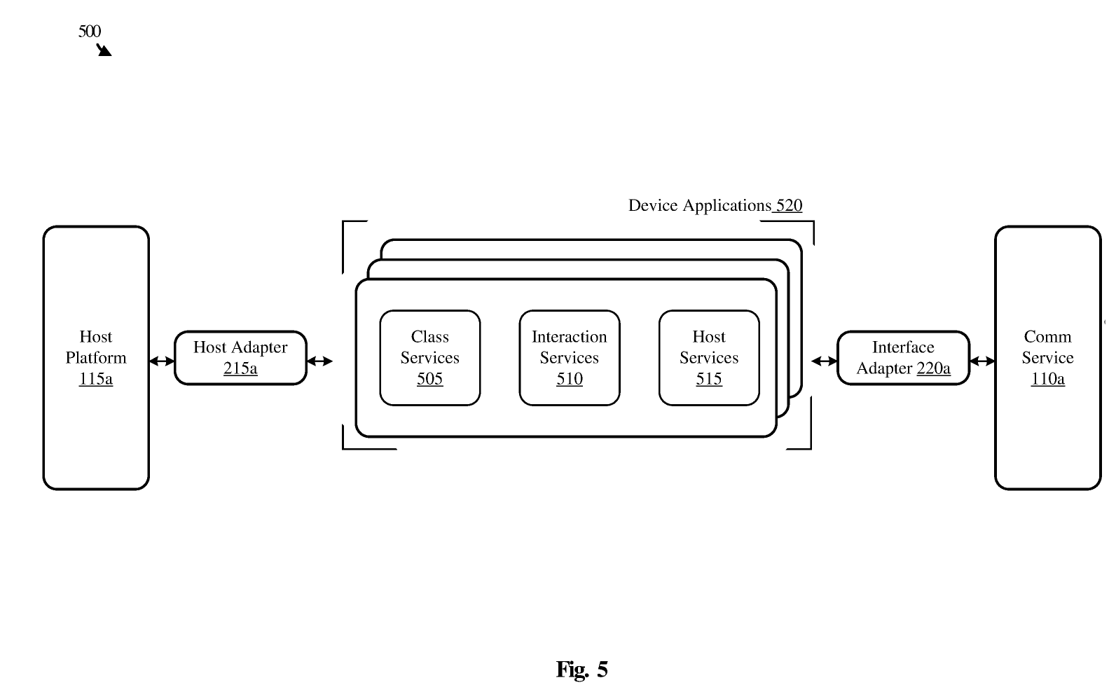

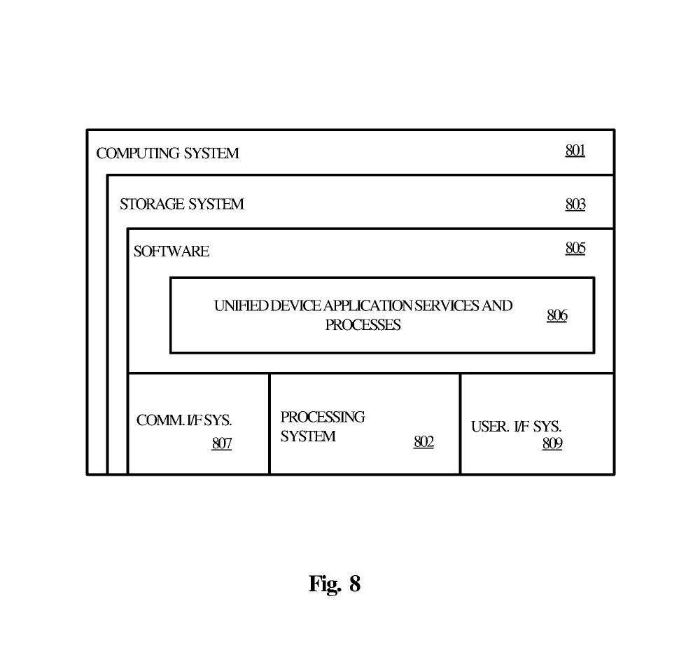

UDA components 105 may be hosted on one or more computing systems (e.g., computing system 801 illustrated and described with respect to FIG. 8). UDA components 105 may be hosted on premises or cloud hosted in various embodiments. In some embodiments, UDA components 105 may be implemented in container orchestration system (e.g., KUBERNETES) environment. UDA components 105 may be considered a datastore. UDA components 105 include highly reusable components (e.g., device application services 230 described and illustrated with respect to FIGS. 2 and 3), components designed from the highly reusable components (e.g., device applications 210, 425 described and illustrated with respect to FIGS. 2 and 4), configuration information, application state information, and interface components. Interface components may include components designed to translate information to and from host platforms 115 as well as interface components designed to translate information to and from communication services 110. As such, host platforms 115 leverage UDA components 105 to provide functionality to user devices 120 and industrial automation devices 130 in factory environment 125 via communication services 110. UDA components 105 are described in more detail with respect to FIGS. 2 and 3. Data flows and methods of using system 100 are depicted and described in detail with respect to FIGS. 5, 6A, 6B, and 7A.

FIG. 2 illustrates additional details of UDA components 105. UDA components includes catalog 205, device applications 210, host adapters 215, interface adapters 220, application state 225, and device application services 230. In some embodiments, UDA components 105 may include categories of other names without departing from the spirit of this disclosure. As discussed with respect to FIG. 1, UDA components 105 may be hosted on premises or in a cloud hosted configuration.

Device application services 230 provide the foundation for the Unified Device Architecture. Device application services 230 are implemented with a flexible Application Programming Interface (API) that supports multiple communication transports and/or protocols. For example, the flexible API may include a Message Queuing Telemetry Transport (MQTT) adapter, a Representational State Transfer (REST) adapter, and a GOOGLE Remote Procedure Call (gRPC) adapter or any combination of adapters that provide flexibility for communicating between various types of industrial automation devices 130, user devices 120, across various types of networks, and with various host platforms 115. Device application services 230 are designed to enable easy integration and adaptation to changing technologies and technology landscapes, facilitate seamless communication across diverse systems, support reusability and maintenance, support network and protocol type flexibility, and be scalable, adaptable, and future-ready. Device application services 230 implement a service that correlates to a particular model or type of industrial automation device 130 (e.g., a drive, a sensor, a programmable logic controller, an I/O device, or the like) or a particular host platform 115. Device application services 230 are illustrated and discussed in more detail with respect to FIGS. 3 and 4.

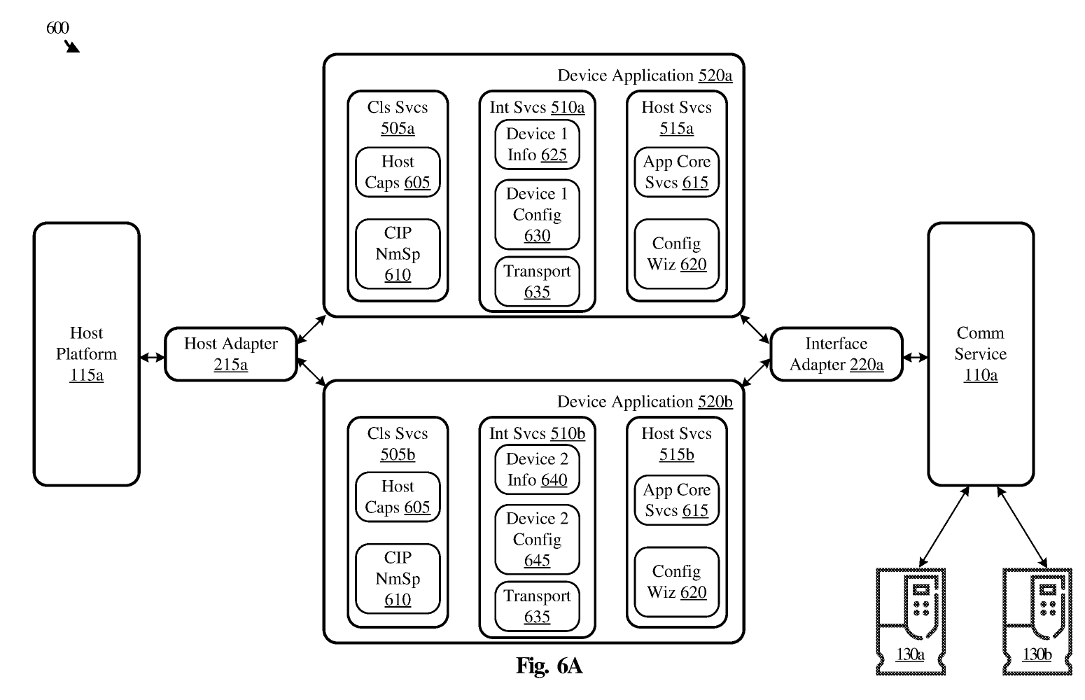

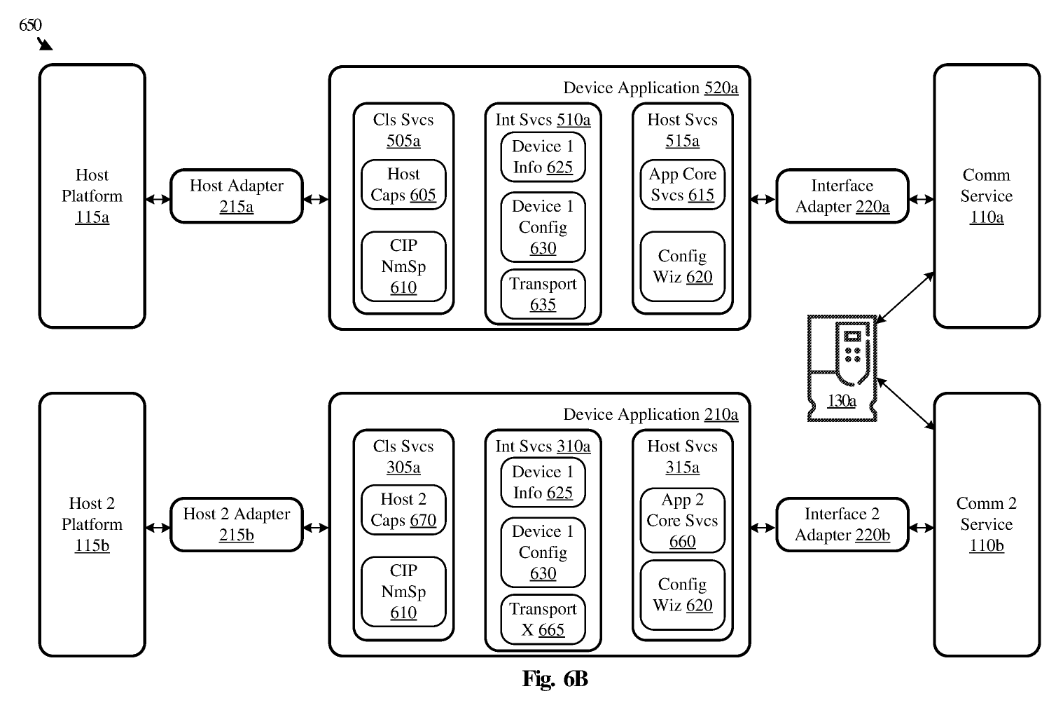

Device applications 210 are developed using a unique combination of device application services 230. Device applications 210 are designed to correspond to a specific type of industrial automation device 130 and a specific host platform 115. For example, to access information about a specific type of variable frequency drive (e.g., industrial automation device 130a) using a device health monitoring application (e.g., host platform 115a), a device application 210 is created using specific device application services 230 that provide the relevant services corresponding to that industrial automation device 130a and that particular host platform 115a. Some of these device application services 230 can be reused for other device applications 210 relevant to other host platforms 115 (e.g., host platform 115b) accessing the same industrial automation device 130a and for the same host platform 115a accessing other industrial automation devices 130 (e.g., industrial automation device 130b). Accordingly, device applications 210 are built fit-for-purpose for corresponding with a specific host platform 115a using the library of shared device application services 230. This concept is depicted and described with respect to FIGS. 6A and 6B.

Device applications 210 are not deployed stand alone. Rather, they are intended to support a specific host platform. In other words, a device application 210 is leveraged by a specific host platform 115a to which it corresponds. Device applications 210 provide functionality for its corresponding host platform 115a to interact with its corresponding industrial automation device 130a.

Host adapters 215 include an adapter for each of the host platforms 115. In other words, there is a host adapter 215 corresponding to each host platform. Host adapters 215 are responsible for translating the content from device applications 210 into the corresponding host platforms 115, allowing the corresponding host platforms 115 to leverage device applications 210. Having a specific host adapter 215 for each of the host platforms 115 ensures that device application services 230 can be written independent of any specific host platform 115a. This facilitates the reusability of the device application services 230 across multiple host platforms 115. Host adapters 215 may perform many tasks including message brokering, handling connections and subscriptions, and the like. Host adapters 215 may provide a direct interface to catalog 205 for host platforms 115, which may be used to “hydrate” host platforms 115 with relevant information for, for example, leveraging the UDA components 105.

Interface adapters 220 include an adapter for each communication service 110. In some embodiments, more than one of host platforms 115 may use a single communication service 110. In some embodiments, there is an interface adapter 220 for each host platform 115. In some embodiments, interface adapters 220 may not be used because interface functionality may be built into device applications 210 with specific device application services 230.

Application state 225 may include data specific to the state of host platforms 115 with respect to a particular instantiation or use by a user. State information, user information, history, and the like may be stored and used by relevant device application services 230 as needed.

Catalog 205 may include a catalog of relevant data for using host platforms 115 with UDA components 105. For example, catalog 205 may include a listing of all the device application services 230, device applications 210, and host platforms 115 deployed for the particular factory environment 125. For example, when deployed as a cloud hosted implementation, there may be a catalog 205 for each tenant that includes details specific to that tenant’s implementation. When deployed on premises, for cost and resource savings, not all device application services 230, device applications 210, or host platforms 115 may be deployed. For example, device application services 230 and device applications 210 specific to an industrial automation device 130 not included in factory environment 125 may not be deployed.

Catalog 205 may further include data related to industrial automation devices 130 including, for example, module types, capabilities, model numbers, lifecycle assessment information, motion information, motion schema information, integration capabilities, device rules, and the like. Catalog 205 may include general information as well as implementation specific information for the particular factory environment 125. Catalog 205 may include factory environment 125 information including, for example, symbolic namespace information, Common Industrial Protocol (CIP) namespace information, DPI namespace information, and the like. Information in catalog 205 may be leveraged by relevant device application services 230 (e.g., class services 305 and 505 described and illustrated with respect to FIGS. 3 and 5).

FIG. 3 illustrates additional details of device application services 230, including a depiction of an example device application service 230a. Device application services 230 includes class services 305, interaction services 310, and host services 315. Device application services 230 may include a device application service 230 for each bit of functionality needed, so each can be general enough for reuse among different host platforms 115 and for different industrial automation devices 130. As discussed above, device application services 230 provide the foundation for the Unified Device Architecture.

Class services 305 are one type of device application service 230. Class services 305 describe the capabilities and data supported by a specific or a specific type of industrial automation device 130. Class services 305 utilize catalog 205 for obtaining information about industrial automation devices 130 including for example, module types, capabilities, model numbers, lifecycle assessment information, motion information, motion schema information, integration capabilities, device rules, and the like. For example, a class service 305 may be leveraged to determine how many I/O ports a particular model of I/O device has. Class services 305 may apply to one model or type of industrial automation device 130, a family of industrial automation devices, or all industrial automation devices that implement a given feature or functionality (e.g., all industrial automation devices that implement Ethernet).

Interaction services 310 are another type of device application service 230. Interaction services 310 allow communication directly with industrial automation devices 130. Interaction services 310 are generally specific to a particular type of industrial automation device 130. For example, an interaction service 310 may be leveraged to read the current value of a sensor. However, it may be relevant to one model or type of industrial automation device 130, a family of industrial automation devices, or all industrial automation devices that implement a given feature or functionality. Interaction services 310 may include services for obtaining device information, for interacting on specific networks, for obtaining device diagnostics, for obtaining motion diagnostics, for configuring the device, and so forth.

Interaction services 310 may also include lower-level services to communicate between the cloud to the edge using device shadows. Device shadows (not shown) are representations of devices in a container orchestration system (e.g., KUBERNETES) or other cloud-based system that allow communication with industrial automation devices 130 that are very stateful in a stateless system. For example, a device shadow representing a particular industrial automation device 130a is created in a container orchestration system. An edge appliance (not shown) interfaces between the device shadow and the industrial automation device 130a. In this way, the industrial automation device 130a, which is not supported in a container orchestration system, is represented within it. Using system 100 and a container orchestration system is possible with device shadows and interaction services 310 that interact with the device shadows. Other systems such as cloud systems or other systems that would not typically communicate with physical industrial automation devices 130 is similarly possible with device shadows.

Host services 315 are yet another type of device application service 230. Host services 315 perform logic to manage information needed by host platforms 115. Host services 315 are specific to a particular host platform 115 or may be common to many host platforms 115. For example, host services 315 may provide host platforms 115 with specific connection services, drive configuration services, rule execution, and so forth that are used for that one particular host platform 115 or a number of host platforms 115.

Accordingly, host services 315, interaction services 310, and class services 305 may be relevant or apply to multiple industrial automation devices 130 and/or multiple host platforms 115. For example, a given service may apply to all EtherNet/IP devices, some EtherNet/IP devices that implement time synchronization, or families of devices (e.g., PowerFlex Drives) that implement common objects.

Device application service 230a illustrates additional details of a device application service 230. Device application service 230a represents any device application service 230. Device application service 230a includes service implementation 320, adapter A 322, adapter B 324, and adapter C 326. Service implementation 320 represents the particular service (e.g., functionality, information) that the device application service 230a provides. In some embodiments, the service implementation may be implemented using more than one programming language (e.g., .Net, Python, Rust, and the like) to be leveraged by multiple host platforms 115. Device application service 230a may be specific to a particular industrial automation device 130a or a particular host platform 115. For example, if device application service 230a is a host service 315, it may provide functionality specific to a particular host platform 115. However, if device application service 230a is an interaction service 310, it may provide functionality specific to a particular industrial automation device 130. Additionally, the flexible API design of device application service 230a includes three adapters, though more or fewer may be used, to facilitate communication across various technologies. For example, adapter A 322 may be an MQTT adapter, adapter B 324 may be a REST adapter, and adapter C 326 may be a gRPC adapter. Accordingly, device application service 230a can be leveraged for use with industrial automation devices 130 and host platforms 115 using various technologies.

FIG. 4 illustrates a UDA development environment 400. While system 100 depicts a deployment for a particular factory environment 125, environment 400 illustrates information relevant to the development of the UDA components 105, host platforms 115, and communication services 110. UDA development environment includes user device 405, development application service 410, and UDA development components 415. UDA development environment 400 may include additional elements not shown here for simplicity.

UDA development components 415 include device application services 420, device applications 425, software host applications 430, interface adapters 435, host adapters 440, and catalog 445. Device application services 420 represent all developed device application services. Device application services 230 may be all of or a subset of device application services 420 depending on whether all were deployed to system 100.

Device applications 425 represent all developed device applications. Device applications 210 may be all of or a subset of device applications 425 depending on whether all were deployed to system 100.

Software host applications 430 represent all host platforms 115 during development. Once software host applications 430 are deployed, they are host platforms 115. Host platforms 115 may be all or a subset of software host applications 430 depending on whether all were deployed to system 100.

Interface adapters 435 represent all developed interface adapters. Interface adapters 220 may be all of or a subset of interface adapters 435 depending on which software host applications 430 were deployed to system 100.

Host adapters 440 represent all developed host adapters. Host adapters 215 may be all of or a subset of host adapters 440 depending on which software host applications 430 were deployed to system 100.

Development application service 410 may represent an interface for a software development environment used for writing executable software using UDA development components 415.

User device 405 interacts with the development application service 410 to access UDA development components 415 in a development interface 407 provided by the software development environment. Development interface 407 is merely depicted to illustrate exemplary steps used for developing UDA development components 415.

For example, developing a device application service (450) includes leveraging the flexible API (e.g., adapter A 322, adapter B 324, adapter C 326 and generating the service implementation (service implementation 320). In some embodiments, developing the device application service may include creating entries in catalog 445 to represent the new device application service or provide other relevant information. Once complete the newly developed device application service can be stored in device application services 420 for reuse in creating device applications 425.

Developing a device application (452) may include selecting the specific device application services 420 to include. As discussed above, a device application 425 includes a unique combination of device application services 420 that correspond to a specific industrial automation device 130a and a specific host platform 115a (i.e., software host application 430). Accordingly, the particular software host application 430 and corresponding host adapter 440 are identified and facilitated, if needed. Similarly, the corresponding interface adapter 435 may be identified and facilitated, if needed. Entries may be placed in catalog 445 to represent the new device application or provide other relevant information. Once complete, the newly developed device application can be stored with device applications 425 in UDA development components 415 (e.g., a datastore) for use by the corresponding host platform 115a when deployed.

Developing a software host application (454) may include developing the software application to leverage the UDA architecture via its corresponding host adapter 440. The host adapter is developed to allow the software host application 430 to interface with the UDA components 105 and particularly with the relevant device applications 425 for performing services. In some embodiments, a communication service 110 is developed specifically for the software host application 430. In some embodiments an interface adapter 435 is developed if needed. Catalog 445 may be updated with relevant entries for the particular software host application 430. The software host application can then be stored in software host applications 430.

Once UDA development components 415 are developed, UDA system 100 can be deployed. Note that in some embodiments, not all device application services 420, device applications 425, software host applications 430, interface adapters 435, host adapters 440, or the complete catalog 445 are deployed depending on the factory environment 125. For example, resources may be saved by limiting deployment to those UDA development components 415 needed to support the particular factory environment 125.

Note that in the development environment 400, after deployment of system 100, new device applications 425 and device application services 420 can be created when, for example, a new industrial automation device is created or released. Further, updates can be made to existing device applications 425 and device application services 420 when changes are needed or desired. These changes can be implemented without modification of software host applications 430 since they do not directly implement the specific functionality provided. Rather, updates to catalog 445 may inform software host applications 430 of new functionality and may be automatically implemented by host adapters 440 by simply deploying the new and/or updated device application services 420 and device applications 425 as well as providing relevant updates in catalog 445 to catalog 205. When a particular device application 425 or device application service 420 is deployed to UDA components 105, the updates are immediate since UDA components 105 is a central point such that all host platforms 115 use the currently available device applications 210 in UDA components 105. This allows for rapid development and deployment of software functionality for industrial automation devices 130 in new and existing deployments of system 100.

FIG. 5 illustrates UDA system 500. UDA system 500 represents a portion of UDA system 100. UDA system 500 includes host platform 115a, host adapter 215a, device applications 210, interface adapter 220a, and communication service 110a.

Host platform 115a is a particular one of host platforms 115. Host adapter 215a is the corresponding host adapter for host platform 115a. Device applications 520 includes the device applications 210 that host platform 115a leverages. In other words, device applications 520 are the device applications that correspond to host platform 115a Device applications 520 include class services 505, interaction services 510, and host services 515. Class services 505 may be particular class services of class services 305 implemented by device applications 520. Interaction services 510 may be particular interaction services of interaction services 310 implemented by device applications 520. Host services 515 may be particular application services of host services 315 implemented by device applications 520. Interface adapter 220a is the corresponding interface adapter for communication service 110a. Communication service 110a may be a general communication service or a particular communication service used for host platform 115a.

In use, communication service 110a provides the user interface (e.g., graphical user interface) to user device 120 and industrial automation devices 130 through which the user can request services. For example, the user may wish to view configuration information for a particular industrial automation device 130a. The request is submitted via communication service 110a. Communication service 110a may pass the request via interface adapter 220a to host adapter 215a (bypassing device applications 520 since they may not be leveraged for receiving a request). Host adapter 215a may provide the request to host platform 115a.

Upon receiving the request, host platform 115a may leverage host adapter 215a to translate the request to identify the particular device application 520 that includes the relevant device application services (e.g., class services 505, interaction services 510, and/or host services 515) for responding to the request. Host adapter 215a may utilize catalog 205, for example, to identify the particular device application 520. Host adapter 215a or the identified device application 520 can invoke the relevant device application services in the identified device application 520 to perform the requested service and respond to the request. For example, one or more interaction services 510 in the device application 520 can be invoked to obtain the configuration information from the particular industrial automation device 130a. Further, one or more host services 515 may be invoked to generate the relevant graphical user interface elements and provide them to interface adapter 220a for display to the user via communication service 110a.

While a specific data flow example is described, other data flows may be used without departing from the spirit of the disclosure. For example, the configuration information may be provided to host platform 115a for processing rather than directly to interface adapter 220a. Regardless of the exact data flow, when host platform 115a receives a request involving interaction or communication with an industrial automation device 130, host platform 115a leverages device applications 520 to perform the service using host adapter 215a to translate the request and identify the particular device application 520 for performing the service.

FIG. 6A illustrates UDA system 600, depicting reuse of device application services (e.g., device application services 230) for different industrial automation devices 130 with a host platform 115a. In UDA system 600, device applications 520 includes device application 520a and device application 520b. Both device application 520a and 520b correspond to host platform 115a. Device application 520a also corresponds to the type of industrial automation device that industrial automation device 130a is (e.g., a variable frequency drive). Device application 520b also corresponds to the type of industrial automation device that industrial automation device 130b is (e.g., a programmable logic controller).

Device application 520a includes specific class services 505a, specific interaction services 510a and specific host services 515a so that the combination of device application services is unique and specific to host platform 115a and a corresponding type of industrial automation device (e.g., a variable frequency drive), in this case the type that industrial automation device 130a is. Note that while device applications and device application services are created for particular types (particular model numbers or families) of industrial automation devices, the coordination of particular information in catalog 205 and coordination between multiple device application services allows a device application 520a to be used to access a particular industrial automation device 130a. Device application 520a may include many other device application services, but those shown here are exemplary for the purpose of depicting the reusability of device application services.

Class services 505a includes host capabilities service 605 that may describe the capabilities of host platform 115a. Class services 505a also includes CIP namespace service 610, which may describe the namespace used for the implementation of Common Industrial Protocol (CIP) in the environment. Class services 505a may include other device application services not depicted here for simplicity.

Interaction services 510a includes Device 1 information service 625, which may be a service that connects to and obtains device information for the type of device (e.g., variable frequency drive). Interaction services 510a also includes device 1 configuration service 630, which may be a service that connects to and obtains device configuration information for the type of device (e.g., variable frequency drive). Interaction services 510a also includes transport service 635, which may be a service that facilitates a particular transport (e.g., Bluetooth, a proprietary transport, or the like) for the type of device. Interaction services 510a may include other device application services not depicted here for simplicity.

Host services 515a includes application core services 615, which may be a service that provides core services of host platform 115a. Host services 515a may also include configuration wizard service 620, which may be a service that provides a configuration wizard for host platform 115a. Host services 515a may include other device application services not depicted here for simplicity.

Device application 520b includes specific class services 505b, specific interaction services 510b, and specific host services 515b so that the combination of device application services is unique and specific to host platform 115a and a corresponding type of industrial automation device (e.g., a programmable logic controller), in this case the type of device that industrial automation device 130b is. Device application 520b may include many other device application services, but those shown here are exemplary for the purposes of depicting the reusability of device application services.

Class services 505b includes host capabilities service 605 and CIP namespace service 610, which are reused between device application 520a and device application 520b. Class services 505b may include other device application services not depicted here for simplicity.

Interaction services 510b includes Device 2 information service 640, which may be a service that connects to and obtains device information for the type of device (e.g., programmable logic controller). Interaction services 510b also includes device 2 configuration service 645, which may be a service that connects to and obtains device configuration information for the particular type of device that industrial automation device 130b is. Interaction services 510b also includes transport service 635, which is used between device application 520a and device application 520b. Interaction services 510b may include other device application services not depicted here for simplicity.

Host services 515b includes application core services 615 and configuration wizard service 620, which are also reused. Note that the host services 515a and 515b are likely very similar since both device application 520a and device application 520b correspond to the same application (i.e., host platform 115a). Host services 515b may include other device application services not depicted here for simplicity.

As shown in system 600, two device applications 520 are leveraged by host platform 115a to provide functionality specific to two different types of industrial automation devices 130a and 130b. However, many individual device application services (e.g., the services within class services 505, interaction services 510, and host services 515) can be reused to create each device application 520.

FIG. 6B illustrates UDA system 650, depicting reuse of device application services (e.g., device application services 230) for different host platforms 115 to support the same industrial automation device 130a. Along the top, host platform 115a uses host adapter 215a to leverage device application 520a to communicate with industrial automation device 130a via communication service 110a using interface adapter 220a as shown and described in system 600.

System 650 further includes a second host platform 115b having a second host adapter 215b for leveraging device application 210a to communicate with industrial automation device 130a via a second communication service 110b using a second interface adapter 220b. Device application 210a includes class services 305a, interaction services 310a, and host services 315a. Class services 305a reuses CIP namespace service 610, but has second host capabilities service 670, which may describe the capabilities of host platform 115b. Interaction services 310a reuses device 1 information service 625 and device 1 configuration service 630 but includes transport X service 665, which may be a service that facilitates a particular transport, which is different than the transport supported by transport service 635 used in interaction services 510a of device application 520a. Host services 315a may reuse configuration wizard service 620 but may include application core services 660, which may provide a service that facilitates core services of host platform 115b.

As shown in system 650, device application 520a is leveraged by host platform 115a to provide functionality specific to industrial automation device 130a, and device application 210a is leveraged by host platform 115b to provide functionality specific to that same industrial automation device 130a. Again, many individual device application services (e.g., the services within class services 505, interaction services 510, and host services 515) can be reused to create each device application 520a and 210a. When implemented in system 100, both device application 520a and device application 210a can be deployed to UDA components 105 so that the reuse can provide resource savings by maintaining and serving the reused device application services in and from one place (i.e., UDA components 105).

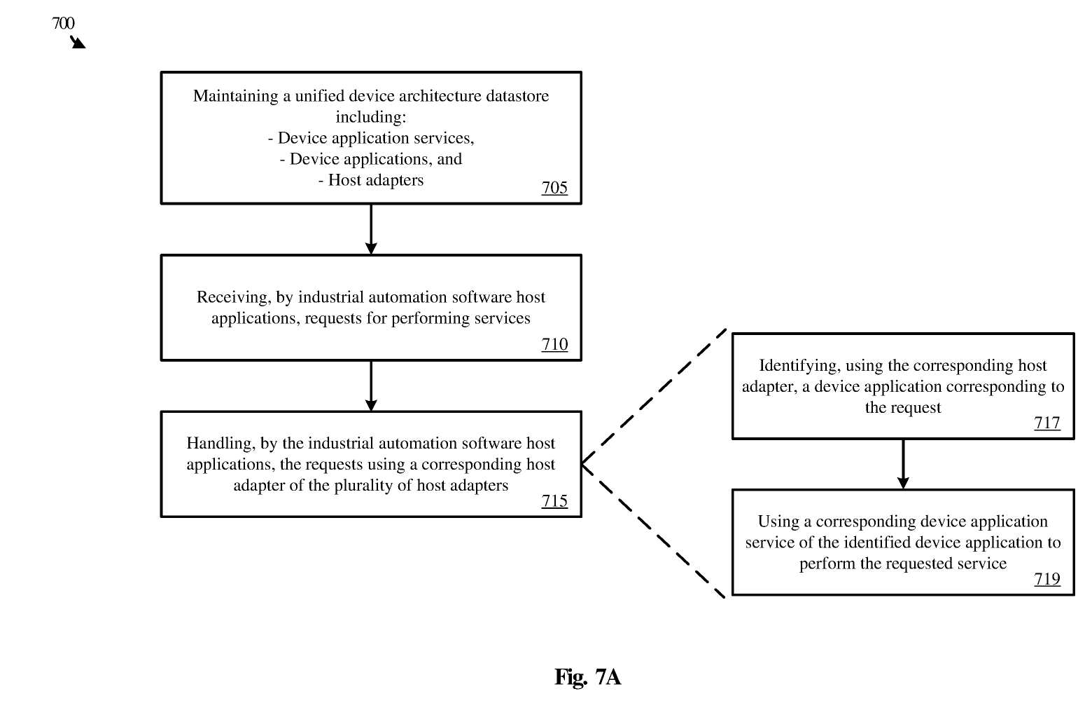

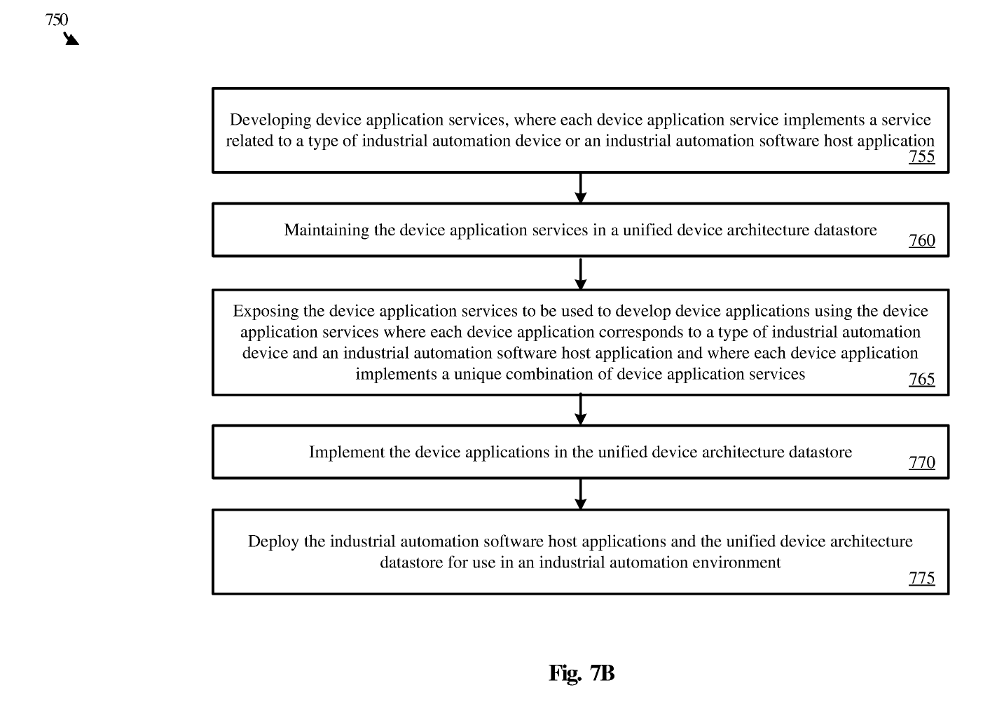

FIG. 7A illustrates a method 700 for leveraging a UDA environment such as system 100. Method 700 may be performed by one or more computing systems (e.g., computing system 801), and particularly by computing systems hosting UDA components 105, host platforms 115, and communication services 110. The steps of method 700 may be performed multiple times and in any order and/or simultaneously. Method 700 includes, at 705, maintaining a unified device architecture datastore that includes device application services, device applications, and host adapters. For example, UDA components 105 may be maintained and include device application services 230, host adapters 215, and device applications 210. As discussed in detail above, each device application service implements a service (e.g., service implementation 320) and a flexible API (e.g., adapter A 322, adapter B 324, adapter C 326). Further, each device application implements a unique combination of device application services. For example, device application 520a includes device application services (e.g., host capabilities service 605, device 1 information service 625, and so forth), some of which are different and some of which are the same as the device application services included in device application 520b (e.g., host capabilities service 605, device 2 information service 640, and so forth). The unique combination of device application services in a device application results in device applications that correspond to one of the host platforms 115 and one type of industrial automation device 130. Additionally, each host adapter corresponds to a particular industrial automation software host application (i.e., a particular host platform 115a).

At 710, industrial automation software host applications receive requests for performing services. For example, host platforms 115 receive requests for interacting with industrial automation devices 130. Interactions may include viewing data from the industrial automation devices 130, updating data or configurations, monitoring status or health, and the like.

At 715, the industrial automation software host applications handle the requests using a corresponding host adapter. For example, when host platform 115a receives a request to view configuration information of industrial automation device 130a, host platform 115a uses host adapter 215a to leverage device application 520a in UDA components 105. More specifically, at 717, the host adapter may identify the relevant device application corresponding to the request (e.g., device application 520a). At 719, one or more relevant device application services in the device application are invoked to perform the requested service.

FIG. 7B illustrates a method 750 for developing a UDA environment such as UDA system 100. Method 750 may be performed by one or more computing systems (e.g., computing system 801), and particularly by computing systems hosting UDA development environment 400, including computing systems that host UDA development components 415, development application services 410, and user device 405. The steps of method 750 may be performed multiple times and in any order and/or simultaneously. Method 750 includes, at 755, developing device application services, where each device application service implements a service related to a type of industrial automation device or an industrial automation host application. For example, development interface 407 may be used to develop a device application service 420, which is deployed in system 100 as a device application service 230. The device application services correspond to a particular host platform 115 or a particular type of industrial automation device 130. For example, a type of industrial automation device may correspond to a particular model number or family of model numbers or devices. Host platforms 115 leverage the device applications implementing the device application services to access or perform services related to a particular instance of an industrial automation device 130 in a factory environment 125. The flexible API is used to generate the device application services that are reusable across different host platforms 115 or for different types of industrial automation devices.

At 760, the device application services are maintained in a unified device architecture datastore. For example, device application services 420 are maintained in UDA development components 415, which may be a datastore.

At 765, the device application services are exposed to be used to develop device applications. For example, device application services 420 are used to develop device applications 425. Each device application 425 corresponds to a particular type of industrial automation device and a particular industrial automation software host application (e.g., software host applications 430). In other words, as described related to deployed device application 520a, it corresponds to host platform 115a and the type of industrial automation device that industrial automation device 130a is, and device application 520a includes a unique combination of device application services (e.g., host capabilities service 605, and so forth).

At 770, the device applications are implemented in the unified device architecture datastore. For example, after developing a device application 425, it is implemented by saving it in UDA development components 415 and relevant entries are added to catalog 445.

At 775, the industrial automation software host applications and the UDA datastore are deployed for use in an industrial automation environment. For example, software host applications 430 are deployed in system 100 as host platforms 115, relevant device application services 420 are deployed to UDA components 105 as device application services 230, and device applications 425 are deployed to UDA components 105 as device applications 210. Further, host adapters 440 are deployed to UDA components 105 as host adapters 215. Once deployed, method 700 may be performed to use the deployed system 100.

FIG. 8 illustrates computing system 801, which is representative of any system or collection of systems in which the various applications, processes, services, and scenarios disclosed herein may be implemented. Examples of computing system 801 include, but are not limited to server computers, web servers, cloud computing platforms, and data center equipment, microcontrollers, micro-controller units (MCUs), as well as any other type of physical or virtual server machine, container, and any variation or combination thereof. In some examples, computing system 801 may also be representative of desktop and laptop computers, tablet computers, and the like.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements unified device application services and processes 806, which are representative of the software components (e.g., device applications 210, host platforms 115, host adapters 215, interface adapters 220, communication services 110) and the processes (e.g., methods 700 and 750) discussed with respect to the preceding FIGS. When executed by processing system 802, software 805 directs processing system 802 to operate as described herein for at least the various processes, operational scenarios, and sequences discussed in the foregoing implementations or to implement the described software as described herein. Computing system 801 may optionally include additional devices, features, or functionality not discussed for purposes of brevity.

Referring still to FIG. 8, processing system 802 may include a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, microcontroller units, graphical processing units, application specific processors, integrated circuits, application specific integrated circuits, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including unified device application services and processes 806) may be implemented in program instructions and among other functions may, when executed by processing system 802, direct processing system 802 to operate as described with respect to the various operational scenarios, sequences, and processes illustrated herein. For example, software 805 may include program instructions for implementing the unified device architecture and application services, processes, and procedures as described herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method, comprising:
developing a plurality of device application services, wherein:
each device application service implements a service related to one of a plurality of types of industrial automation devices or one of a plurality of industrial automation software host applications;
maintaining the plurality of device application services in a unified device architecture datastore;
exposing the plurality of device application services to be used to develop a plurality of device applications using the plurality of device application services, wherein:
each device application of the plurality of device applications corresponds to one of the plurality of types of industrial automation devices and one of the plurality of industrial automation software host applications, and
each device application of the plurality of device applications implements a unique combination of one or more device application services of the plurality of device application services;
implementing the plurality of device applications in the unified device architecture datastore; and
deploying the plurality of industrial automation software host applications and the unified device architecture datastore for use in an industrial automation environment.

2. The computer-implemented method of claim 1, further comprising:
implementing a plurality of host adapters in the unified device architecture datastore, wherein:
each host adapter of the plurality of host adapters corresponds to one of the plurality of industrial automation software host applications; and
each host adapter of the plurality of host adapters facilitates the corresponding industrial automation software host application to use device applications of the plurality of device applications that correspond to the respective industrial automation software host application.

3. The computer-implemented method of claim 1, wherein:
each device application service implements a flexible Application Programming Interface (API) having a plurality of communication adapters; and
the plurality of device applications implement the device application services with the respective flexible API.

4. The computer-implemented method of claim 1, further comprising:
updating one or more device application services of the plurality of device application services in the deployed unified device architecture datastore without modifying or updating the corresponding deployed industrial automation software host application or any of the plurality of device applications that implement the updated one or more device application services in the deployed unified device architecture datastore.

5. The computer-implemented method of claim 1, further comprising:
updating one or more device applications of the plurality of device applications in the deployed unified device architecture datastore without modifying or updating the corresponding deployed industrial automation software host application.

6. The computer-implemented method of claim 1, further comprising:
adding a new device application service to the plurality of device application services in the deployed unified device architecture datastore; and
updating a first device application of the plurality of device applications in the deployed unified device architecture datastore to implement the new device application service, wherein:
the first device application corresponds to a first industrial automation software host application of the plurality of industrial automation software host applications, and
the first industrial automation software host application uses the new device application service to handle requests without modifying or updating the first industrial automation software host application.

7. The computer-implemented method of claim 1, further comprising:
adding a new device application to the plurality of device applications in the deployed unified device architecture datastore, wherein:
the new device application corresponds to a first industrial automation software host application of the plurality of industrial automation software host applications, and
the first industrial automation software host application uses device application services implemented by the new device application to handle requests without modifying or updating the first industrial automation software host application.

8. The computer-implemented method of claim 1, wherein the industrial automation environment is a first industrial automation environment, the method further comprising:
deploying a second unified device architecture datastore and one or more of the plurality of industrial automation software host applications for use in a second industrial automation environment, wherein the second unified device architecture datastore does not include device application services that are unused in the second industrial automation environment, device applications that are unused in the second industrial automation environment, or a combination thereof.

9. The computer-implemented method of claim 8, wherein device application services are unused or device applications are unused because the second industrial automation environment does not include a corresponding industrial automation software host application.

10. The computer-implemented method of claim 8, wherein device application services are unused or device applications are unused because the second industrial automation environment does not include a corresponding industrial automation device.

11. A unified device architecture system, comprising:
a unified device architecture datastore comprising a plurality of device application services, wherein:
each device application service implements a service related to one of a plurality of types of industrial automation devices or one of a plurality of industrial automation software host applications;
one or more processors; and
one or more memories having stored thereon instructions that, upon execution by the one or more processors, cause the one or more processors to:
expose the plurality of device application services to be used to develop a plurality of device applications using the plurality of device application services, wherein:
each device application of the plurality of device applications corresponds to one of the plurality of types of industrial automation devices and one of the plurality of industrial automation software host applications, and
each device application of the plurality of device applications implements a unique combination of one or more device application services of the plurality of device application services;
implement the plurality of device applications in the unified device architecture datastore; and
deploy the plurality of industrial automation software host applications and the unified device architecture datastore for use in an industrial automation environment.

12. The unified device architecture system of claim 11, wherein the instructions comprise further instructions that, upon execution by the one or more processors, cause the one or more processors to:
implement a plurality of host adapters in the unified device architecture datastore, wherein:
each host adapter of the plurality of host adapters corresponds to one of the plurality of industrial automation software host applications; and
each host adapter of the plurality of host adapters facilitates the corresponding industrial automation software host application to use device applications of the plurality of device applications that correspond to the respective industrial automation software host application.

13. The unified device architecture system of claim 11, wherein:
each device application service implements a flexible Application Programming Interface (API) having a plurality of communication adapters; and
the plurality of device applications implement the device application services with the respective flexible API.

14. The unified device architecture system of claim 11, wherein the instructions comprise further instructions that, upon execution by the one or more processors, cause the one or more processors to:
update one or more device application services of the plurality of device application services in the deployed unified device architecture datastore without modifying or updating the corresponding deployed industrial automation software host application or any of the plurality of device applications that implement the updated one or more device application services in the deployed unified device architecture datastore.

15. The unified device architecture system of claim 11, wherein the instructions comprise further instructions that, upon execution by the one or more processors, cause the one or more processors to:
update one or more device applications of the plurality of device applications in the deployed unified device architecture datastore without modifying or updating the corresponding deployed industrial automation software host application.

16. The unified device architecture system of claim 11, wherein the instructions comprise further instructions that, upon execution by the one or more processors, cause the one or more processors to:
add a new device application service to the plurality of device application services in the deployed unified device architecture datastore; and
update a first device application of the plurality of device applications in the deployed unified device architecture datastore to implement the new device application service, wherein:
the first device application corresponds to a first deployed industrial automation software host application of the plurality of deployed industrial automation software host applications, and
the first deployed industrial automation software host application uses the new device application service to handle requests without modifying or updating the first deployed industrial automation software host application.

17. The unified device architecture system of claim 11, wherein the instructions comprise further instructions that, upon execution by the one or more processors, cause the one or more processors to:
add a new device application to the plurality of device applications in the deployed unified device architecture datastore, wherein:
the new device application corresponds to a first deployed industrial automation software host application of the plurality of deployed industrial automation software host applications, and
the first deployed industrial automation software host application uses device application services implemented by the new device application to handle requests without modifying or updating the first deployed industrial automation software host application.

18. The unified device architecture system of claim 11, wherein the industrial automation environment is a first industrial automation environment, and wherein the instructions comprise further instructions that, upon execution by the one or more processors, cause the one or more processors to:
deploy a second unified device architecture datastore and one or more of the plurality of industrial automation software host applications for use in a second industrial automation environment, wherein the second unified device architecture datastore does not include device application services that are unused in the second industrial automation environment, device applications that are unused in the second industrial automation environment, or a combination thereof.

19. The unified device architecture system of claim 18, wherein device application services are unused or device applications are unused because the second industrial automation environment does not include a corresponding industrial automation software host application.

20. The unified device architecture system of claim 18, wherein device application services are unused or device applications are unused because the second industrial automation environment does not include a corresponding industrial automation device.
